(19) United States
(12) Patent Application Publication
(10) Pub. No.: US 2004/0234306 A1
(43) Pub. Date: Nov. 25, 2004

(54) Fuser roll for xerographic printing having spiral support ribs

(75) Inventors: Barry J. Gheer, Rochester, NY (US); James A. Herley, Churchville, NY (US); Kenneth R. Rasch, Fairport, NY (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 10/441,566

(22) Filed: May 20, 2003

(51) Int. Cl. G03G 15/20

(52) U.S. Cl. 399/330; 399/331

(57) ABSTRACT

A fuser roll as used in xerographic printing includes an outer wall defining a cylindrical surface. On an interior surface of the roll is defined one or more spiral ribs to support the structure of the roll. The rib may be formed of one piece with the outer wall, or the rib can be attached to the inner surface by an adhesive.

### TECHNICAL FIELD

The present disclosure relates to fuser rolls, as are used in xerographic and other types of printing.

### BACKGROUND

In xerographic and other forms of printing, the idea of “fusing” or “fixing” an image onto a print or copy sheet is well known. Marking material, such as toner, which is initially placed on a print sheet in imagewise fashion is heated to a predetermined temperature, typically in combination with applied pressure, to melt the marking material onto print sheet, yielding a permanent image. The most common apparatus for fusing is a combination of a fuser roll and backing roll, which together form a nip for passing sheets therethrough. Typically, the fuser roll, which faces the image to be fused, is provided with an internal heating element which heats the sheet as it passes through the nip.

In the design of fusing apparatus, an important concern is the overall heat-distribution characteristics of the system. Generally, to obtain an efficient system in which heat is effectively distributed toward the fuser nip, it has been known to provide a fuser roll which is lightweight, typically including a relatively thin outer wall. The known drawback of such a lightweight fuser roll is durability: a lighter fuser roll is apt to wear out sooner, or otherwise become damaged.

### PRIOR ART

U.S. Pat. No. 4,348,579 discloses a fuser roll in which a thin outer wall is reinforced with a series of longitudinal ribs on the inside of the roll.

U.S. Pat. Nos. 5,708,949 and 6,516,177 each disclose a fuser roll in which a thin outer wall is reinforced with a series of rigid circular plates on the inside of the roll.

U.S. Pat. No. 6,327,455 discloses a backing roll in which a thin outer wall is reinforced with a series of longitudinal ribs on the inside of the roll. The longitudinal ribs extend toward a central axle of the roll.

### SUMMARY OF THE INVENTION

According to one aspect of the present invention, there is provided a roll useful in fusing marking material to a print sheet, comprising an outer wall defining a cylindrical outer surface, and an interior surface. At least one rib is attached to the interior surface, the rib having a spiral configuration.

According to another aspect of the present invention, there is provided a roll useful in fusing marking material to a print sheet, comprising an outer wall defining a cylindrical outer surface, and an interior surface. At least one groove is defined in the interior surface, the rib having a spiral configuration.

According to another aspect of the present invention, there is provided a printing apparatus, comprising a first roll and a second roll, forming a nip for the passage of a sheet therethrough. At least one roll includes an outer wall defining a cylindrical outer surface and an interior surface, and at least one rib attached to the interior surface, the rib having a spiral configuration.

### BRIEF DESCRIPTION OF THE DRAWINGS

FIG. 1 is a simple elevational view of a printer using a fuser.

FIG. 2 is an elevational view of a roll useful in a fuser, shown end-on.

FIG. 3 is a simplified perspective view of the roll shown in FIG. 2, showing the configuration of a single rib.

FIG. 4 is an elevational view of another embodiment of a roll useful in a fuser, shown end-on.

FIG. 5 is a simplified perspective view of another embodiment of a roll useful in a fuser.

### DETAILED DESCRIPTION

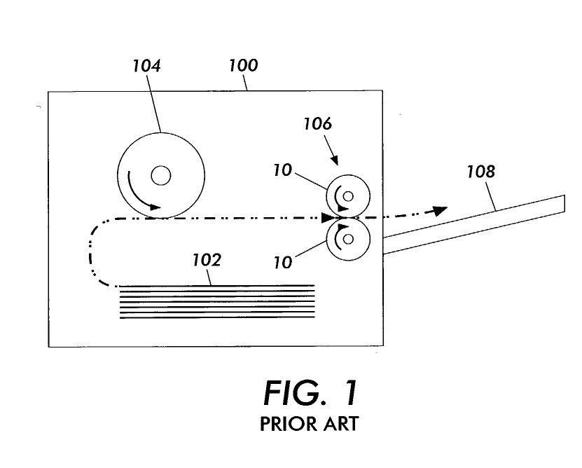

FIG. 1 is a simple elevational view of a printer using a fuser. In this case, the printer 100 is basically of the electrostatic or xerographic type, although fusers may also be used ion other types of printers. In printer 100, sheets are drawn from stack 102 and brought into contact with a rotating photoreceptor 104, to receive marking material in imagewise fashion. The steps of obtaining such an image according to the xerographic process are generally well known. After separating from photoreceptor 104, each sheet is passed through a nip formed by rollers 10, which together form a fuser 106. As mentioned above, the combination of heat and pressure provided in fuser 106 causes loose marking material such as toner to partially melt onto the sheet to form a permanent image on the sheet, which is them deposited in tray 108.

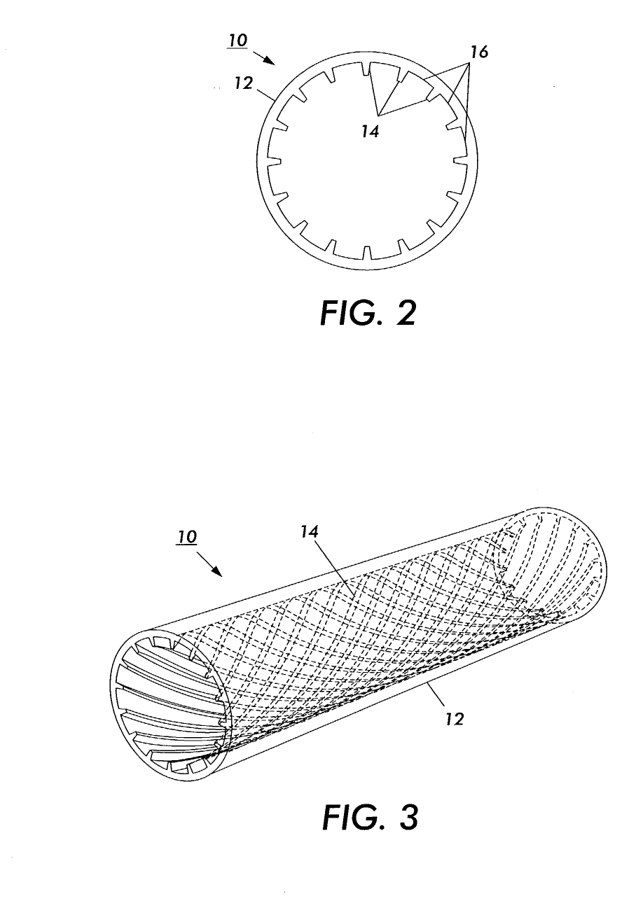

FIG. 2 is an elevational view of a roll useful in a fuser, shown end-on. For present purposes the roll 10 shown in the Figure can be a fuser roll (intended to face the imaged side of a sheet, and typically provided with an internal heat element) or a backing roll (which cooperates with the fuser roll to form a nip). As shown, the roll 10 defines a wall with a cylindrical outer surface 12, and an interior surface. Disposed on the interior surface are a number of ribs 14, which can be said to be defined or separated by grooves 16 therebetween. In this embodiment, the ribs 14 extend toward the axis of the cylindrical surface 12.

FIG. 3 is a simplified perspective view of the roll shown in FIG. 2, showing the configuration of the ribs 14. It can be seen that each rib 14 is configured in a spiral or helical fashion along an effective length of roll 10. Depending on the embodiment, each rib 14 is angled to complete at least half a circumference of the roll along an effective length of the cylindrical surface.

The spiral ribs such as 14 can contribute to the structural stability of the roll 10 and thus facilitate a roll which is relatively light, and, in the case of a fuser roll, can make possible desirable heat-distribution properties. The fact that the ribs 14 are spiral allows the ribs 14 to contribute to structural support both around the circumference and along the longitudes of roll 10: in contrast, to take the example of the '579 patent mentioned above, where the internal ribs are longitudinal, further, disk-shaped supporting members are also desirable.

There are numerous possible strategies for obtaining the spiral ribs 14 on the interior surface of roll 10. In one strategy, material (such as plastic) for making the roll is extruded through an opening having the general shape of the cross-section shown in FIG. 2, and the emerging roll 10 is rotated during the extrusion process to yield spiral ribs which are formed of one piece with the outer wall. Alternately, an initial workpiece with a smooth interior surface and thick wall is provided, and the grooves 16 are cut in, much in the manner of rifling a gun barrel, leaving the spiral ribs 14, again of one piece with the outer wall. Alternately, one or more ribs such as 14 are provided by one or more coils, such as of metal wire or plastic, which are rigidly attached to the interior surface of roll 10, such as with an adhesive.

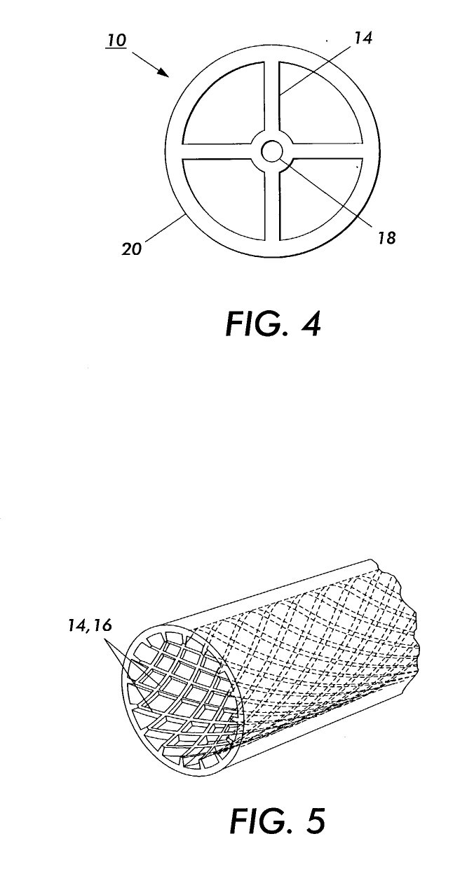

In another embodiment, such as shown in FIG. 4, there is provided what can be called an “axle sleeve” 16, meaning a sleeve at the axis of roll 10, through which an axle (not shown) could be extended. In this embodiment, each rib 14 extends to the axle sleeve 16, but exhibits a spiral shape as in FIG. 3. Also shown in FIG. 4, but which is applicable to any embodiment shown herein, is the presence of an outer sleeve 20, which is attached to the outer surface of roll 10. The outer sleeve 20 can exhibit any desired property for a given context, such as a certain frictional coefficient, resilience, heat conductivity, electrical resistivity, etc.

In another embodiment, shown in FIG. 5, there is provided in effect two “crossing” sets of spiral ribs 14, forming a net-like configuration in combination with neighboring ribs (not shown). In such an embodiment, one set of ribs 14 can be formed by an extrusion process, while the crossing set of ribs, spiraling in an opposite direction, can be made externally and attached. Alternately, there may be two crossing sets of grooves 16, as though the interior surface of roll 10 were rifled in two directions.

1. A roll useful in fusing marking material to a print sheet, comprising:
an outer wall defining a cylindrical outer surface, and an interior surface; and
at least one rib attached to the interior surface, the rib having a spiral configuration.

2. The roll of claim 1, the rib encompassing at least half a circumference of the roll over an effective length of the roll.

3. The roll of claim 1, the rib encompassing at least one circumference of the roll over an effective length of the roll.

4. The roll of claim 1, comprising at least four ribs attached to the interior surface, each rib having a spiral configuration.

5. The roll of claim 1, further comprising an axle sleeve disposed near an axis of the roll, and wherein the rib extends to the axle sleeve.

6. The roll of claim 1, wherein the at least one rib has a spiral configuration in a first direction, and further comprising a second rib having a spiral configuration in a second direction opposite the first direction.

7. The roll of claim 1, wherein the rib is formed of one piece with the outer wall.

8. The roll of claim 1, wherein the rib is attached to the interior surface by an adhesive.

9. The roll of claim 1, wherein the at least one rib has a spiral configuration in a first direction, and further comprising a second rib having a spiral configuration in a second direction opposite the first direction; and
the first rib is formed of one piece with the outer wall and the second rib is attached to the interior surface by an adhesive.

10. A roll useful in fusing marking material to a print sheet, comprising:
an outer wall defining a cylindrical outer surface, and an interior surface; and
at least one groove defined in the interior surface, the groove having a spiral configuration.

11. The roll of claim 10, the groove encompassing at least half a circumference of the roll over an effective length of the roll.

12. The roll of claim 10, the groove defining at least one circumference of the roll over an effective length of the roll.

13. The roll of claim 10, wherein the at least one groove has a spiral configuration in a first direction, and further comprising a second groove having a spiral configuration in a second direction opposite the first direction.

14. A printing apparatus, comprising:
a first roll and a second roll, forming a nip for the passage of a sheet therethrough;
wherein at least one roll includes an outer wall defining a cylindrical outer surface and an interior surface, and at least one rib attached to the interior surface, the rib having a spiral configuration.

15. The apparatus of claim 14, the rib encompassing at least half a circumference of the roll over an effective length of the roll.

16. The apparatus of claim 14, wherein the at least one rib has a spiral configuration in a first direction, and further comprising a second rib having a spiral configuration in a second direction opposite the first direction.

17. The apparatus of claim 14, wherein the rib is formed of one piece with the outer wall.

18. The apparatus of claim 14, wherein the rib is attached to the interior surface by an adhesive.

19. The apparatus of claim 14, wherein the at least one rib has a spiral configuration in a first direction, and further comprising a second rib having a spiral configuration in a second direction opposite the first direction; and
the first rib is formed of one piece with the outer wall and the second rib is attached to the interior surface by an adhesive.

20. The apparatus of claim 14, wherein the first roll and second roll form a fuser.
